(19) United States
(12) Patent Application Publication
(10) Pub. No.: US 2017/0243709 A1
(43) Pub. Date: Aug. 24, 2017

(54) TRANSDUCER-CONTROLLED SWITCH

(71) Applicant: HYDAC ELECTRONIC GMBH, Saarbruecken (DE)

(72) Inventor: Joachim MORSCH, Marpingen (DE)

(21) Appl. No.: 15/509,241

(22) PCT Filed: Aug. 12, 2015
(86) PCT No.: PCT/EP2015/001663

§ 371 Date: Mar. 7, 2017

(30) Foreign Application Priority Data
Sep. 8, 2014 (DE) 10 2014 013 253.6

(51) Int. Cl. H01H 47/22; H01H 9/54

(52) U.S. Cl. CPC H01H 47/223; H01H 9/54

(57) ABSTRACT

An apparatus for controlling the electrical connection of an electrical load (2), which is arranged at a distance from the apparatus, to a control voltage source (4) which is associated with said electrical load, wherein control is performed by means of two control lines (6, 8) which bridge the physical distance between the apparatus and the load plus the control voltage source and which are connected to a control output (10, 12) of the apparatus, wherein the apparatus has a transducer (14) which detects the value of a state variable (16) of a fluid, and wherein control of the connection is performed depending on the respectively detected value of the state variable (16) exceeding and/or falling below a selectable threshold value, is characterized in that the transducer is formed by a measurement transducer (14) which converts the value of the respectively detected state variable (16) into an electrical signal (18), in that the apparatus has an electronics device (20) for evaluating said electrical signal (18) and for controlling the connection depending on the evaluation, in that the connection is made by means of a controllable electronic switching device (26), which is connected to the control output (10, 12), of the apparatus at least over a first predefinable time period, and in that the power supply device of the apparatus is fed from the voltage of the control voltage source (4) which is applied to the control output (10, 12) of the apparatus via the control lines (6, 8), depending on the switching state of the electronic switching device (26), at least over a further second time period which lies outside the first time period.

The invention relates to an apparatus for controlling the electrical connection of an electrical consumer, which is situated at a distance from the device, to a control voltage source associated with said electrical load, wherein the control is performed by means of two control lines, which bridge the spatial distance between the apparatus and the consumer along with the control voltage source, and which are connected to a control of the apparatus, wherein the apparatus includes a transducer, which detects the value of a state variable of a fluid, and wherein the connection is controlled as a function of the respectively detected value of the state variable exceeding and/or falling below a selectable threshold value.

Transducer-controlled switches of this type are prior art and are frequently employed as so-called pressure switches, for example, for actuating a pump motor as a function of the pressure of a fluid. Thus, the French patent specification FR 1 250 613 discloses a pressure switch, which may be used to maintain a predefined pressure in a hydraulic system. In particular, the known solution allows the pressure to be kept within predefinable threshold values. This is achieved in that the system pressure actuates a mechanical switch via a suitable transducer, the switch itself being able to activate a pump driven by an electric motor. In the known solution, a diaphragm subjected to the system pressure is provided as the transducer, which, in turn, acts on a piston provided with an actuator rod, the piston itself being mounted for displaceable movement against the action of a coil spring. With sufficient pressure on the diaphragm, the piston, together with the actuator rod, experiences a displacement, such that the actuator rod actuates an actuation lever of the electric switch and thereby triggers a switching operation. Once the fluid pressure drops, the piston of the transducer is moved back due to the spring force of the coil spring, thereby triggering an inverse switching operation.

In current applications of such pressure switches, there is often a long distance between the electrical consumer to be actuated (for example, the motor of a pump) and the transducer, together with the switch, wherein such a distance is routinely bridged by a twin-core control line, which allows the electrical consumer at the remote location to be connected to the control voltage source situated there in order thereby, for example, to activate a pump.

Such mechanical solutions, as demonstrated in the prior art document FR 1 250 613, have proven reliable over a long period of time, today, however, it is possible to meet significantly more challenging demands, in particular, with the aid of electrical transducers in conjunction with suitable control electronics.

However, a simple substitution of the known mechanical solutions for more modern electronic solutions is not possible, since such electronic solutions each require a power supply, such that in addition to control lines for connecting the consumer, two additional lines must be guided over the distance in order to provide the relevant control electronics with a corresponding supply voltage.

Thus, the stated object of the invention is to replace the devices from the aforementioned prior art with more efficient apparatuses without, however, requiring unreasonable costs or installation effort in the process.

According to the invention, this object is achieved by an apparatus, which includes the features of claim 1 in its entirety.

According to the characterizing portion of claim 1, a significant feature of the invention is that the transducer is formed by a measurement transducer, which converts the value of the respectively detected state variable into an electrical signal, in that the apparatus has an electronics device for evaluating said electrical signal and for controlling the connection as a function of the evaluation, in that the connection is made by means of a controllable electronic switching device, which is connected to the control output of the apparatus, at least over a first predefinable time period, and in that the power supply device of the apparatus, depending on the switching state of the electronic switching device, is fed from the voltage of the control voltage source present at the control output of the apparatus via the control lines, at least over a further, second time period, which falls outside the first time period.

The result of this, in particular, is that no additional lines are required to be laid, in particular, over a long distance, in order to supply power to the electronics device. This comes in useful, in particular, when the existing control lines are situated in an explosive area, since changes and, in particular, extensions of the current-conducting pipeline network would result in extremely high costs.

In particularly advantageous exemplary embodiments, the electronic switching device of the apparatus has two switch outputs, each of which is connected to one of the control outputs, and a control input, wherein each switch output is connected to one control line each at the ends of the control lines on the side of the apparatus. In this way, the apparatus according to the invention can be easily employed during installations, which already include control lines bridging the distance between the apparatus and the consumer along with the control voltage source, and, in particular, can be connected to said control lines.

In particularly advantageous exemplary embodiments, the switching device includes a conductive or a non-conductive state between the two switch outputs as a function of a control signal present at the control input. As a result, it is possible to easily replace conventional switches, for example, mechanical switches, which may be switched between a switched-on state and a switched-off state, with the switching device of the apparatus according to the invention.

The switching device in one embodiment may be controlled in that, on the one hand, the switching device is set to the conductive state during the first time period and there is a connection and, on the other hand, said switching device being set to the non-conductive state during the second time period, the voltage present at the switch outputs originating from the control voltage source feeds the power supply device of the apparatus. As a result, the spatially remotely situated control voltage source in the apparatus according to the invention is thus primarily beneficial for two purposes depending on the control of the switching device, namely ensuring the supply of energy to a remotely situated consumer, as well as the feeding of the power supply of the apparatus. This results in the advantage according to the invention that no additional voltage source for supplying the apparatus is required at the location of the apparatus itself. What is, in particular, achieved by this is that no additional current-conducting lines are required to be installed for supplying the power supply device of the apparatus.

In one advantageous embodiment of the apparatus, the control voltage source is an AC voltage source and the sum of the duration of the first, pre-definable time period and the second time period equals the duration of one or multiple half-oscillations of the AC voltage source.

It may be advantageously provided that the electronic switching device is controlled in synchrony with the control voltage source as part of a phase angle control of the apparatus.

In another advantageous exemplary embodiment of the invention, it is provided that the phase angle control controls the first time period in such a way that during periodic recurrence of this time period, the average current intensity flowing through the consumer as so-called holding current intensity is just sufficient enough to maintain a function of the consumer, for example, the closed state of a relay contact, if the consumer is formed by the relay coil of a relay. Aside from the resulting energy saving while maintaining a desired state of the consumer, this also results in only a minimal heating of the consumer, which is an advantage, in particular, in explosive areas. In addition, corresponding cooling measures for cooling the consumer based on holding current technology may also be reduced, so that installation space and/or weight may be saved.

In one advantageous embodiment of the apparatus according to the invention, it is provided that the phase angle control connects the electronic switching device preferably during zero crossings of the voltage of the control voltage source, or during zero crossings of the current through the remotely situated consumer. This results on the one hand in less wear to the electronic switching device and to the parts connected thereto and, on the other hand, such a “soft” switching has the effect that lower interference signal levels and a narrower bandwidth of interference signals are generated by the switching operations.

In advantageous embodiments of the apparatus, the electronic switching device is formed at least partially by at least one semiconductor component, which is switchable between a conductive and a non-conductive state. This may be, for example, a triac, a thyristor, a bipolar transistor, an insulated gate bipolar transistor (IGBT), a field effect transistor or a semiconductor relay or a combination of the aforementioned components.

At least a part of the apparatus is preferably supplied with a supply voltage, which is provided by the power supply device galvanically from the control voltage source, for example, is isolated via a first transformer. In this way, sensitive components of the apparatus in particular, which include sensors, for example, can be protected from damaging interferences.

The galvanic isolation, in particular, by a transformer also serves as insulation between the load circuit, which includes the consumer along with the control voltage source, of circuit elements, which constitute the measurement transducer, for example, in the form of a pressure sensor, a display device or an input device, in particular, for inputs of an operator of the device. Such insulation requirements are a direct result of the corresponding standards on apparatuses in explosive areas and of the requirements for guaranteeing the safety of operating personnel in compliance with the regulations on voltage insulation.

The apparatus preferably includes a feedback output for the switching state of the electronic switching device, which is formed, for example, by an open collector. In addition, a visual display, for example, in the form of indicator lights and/or means for an acoustic signaling of the switching state may be additionally or alternatively provided.

The apparatus according to the invention may be particularly advantageously employed, if the state variable of the fluid is formed by the pressure of the fluid, wherein additional measurement transducers may be additionally or alternatively provided, which are considered in the evaluation for controlling the electronic switching device. Additional state variables in the form of flow velocity, viscosity, degree of contamination or temperature of the fluid may also be detected, for example.

Particular embodiments of the apparatus may also be provided at least with a display device for displaying at least one state variable and/or the state of the electronic switching device. In addition, the electronics device may include an input device, in particular, in the form of switches and/or push buttons for setting the at least one threshold value and/or for parameterizing the device via a menu control.

In one particularly preferred embodiment of the apparatus according to the invention, the latter includes a housing of the type, such that the apparatus in the form of a retrofit unit may replace a normal, conventional mechanical switch, which includes a mechanical transducer for a state variable of the fluid and no power supply itself. This is advantageous, in particular, when employing the device in systems in which special protection against explosion must be maintained, since changes in the installation of such systems may be associated with significant costs if, once changes are made, a re-determination and re-assessment of the dangers of explosion become necessary.

If, on the other hand, the apparatus according to the invention is provided with a suitable housing and, in particular, with suitable connections or plug connectors, so that the apparatus is easily exchangeable for a conventional, mechanical switch, the costs for complying with the regulations on explosion protection and, in particular, for taking precautions in order to achieve the goals of explosion protection may be significantly reduced.

The invention is explained in detail below with reference to an exemplary embodiment depicted in the drawing, in which:

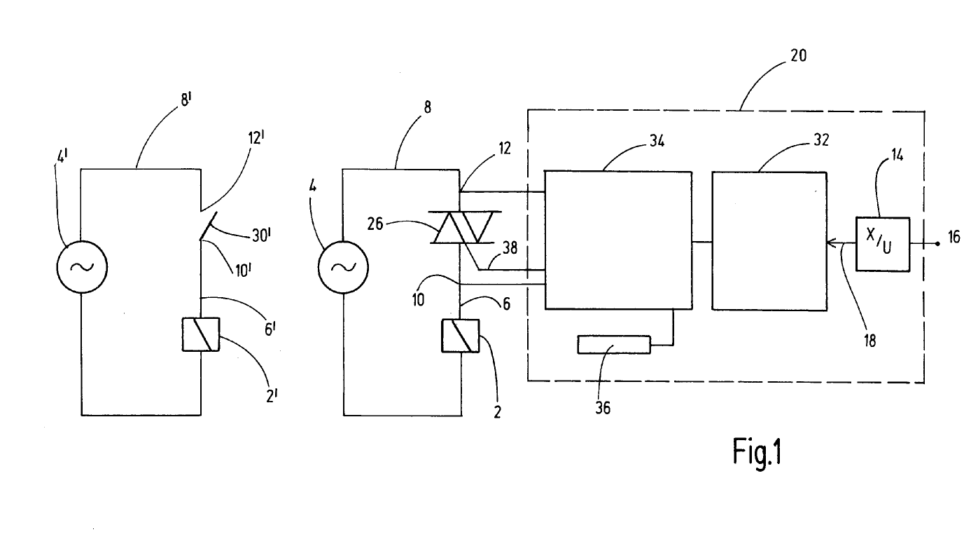

FIG. 1 shows the arrangement of a conventional, mechanical pressure switch in series with the control coil of a motor relay in the left image portion; in the right image portion, a schematic view of a transducer-controlled switch according to the invention;

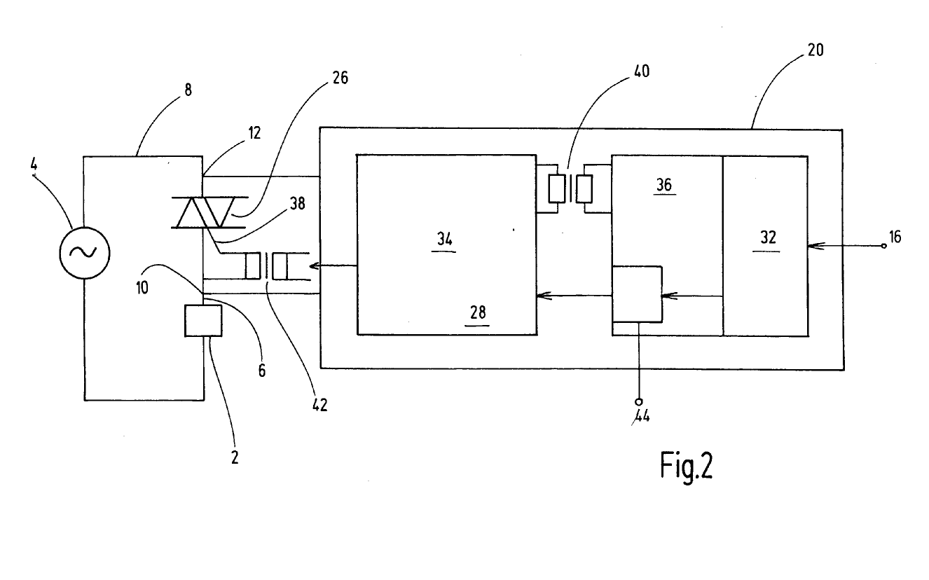

FIG. 2 shows a device according to the invention with a detailed depiction of the control of the electronic switching device;

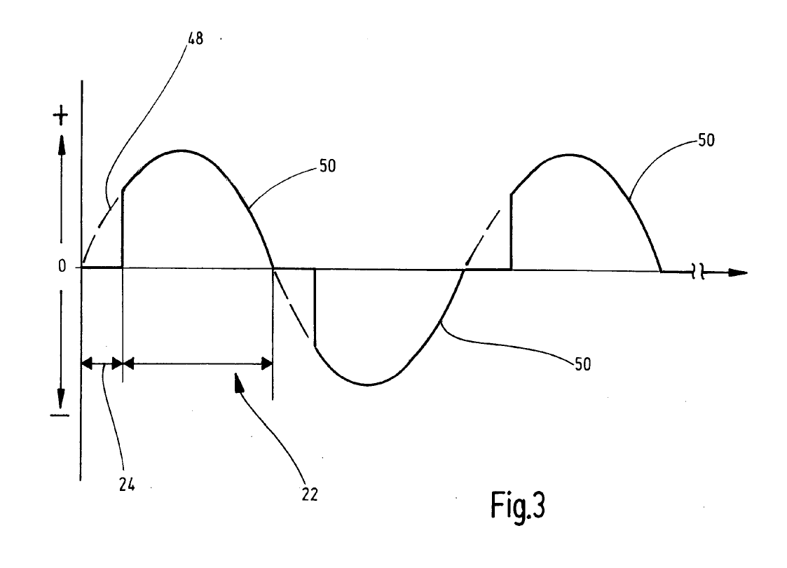

FIG. 3 shows a schematic depiction of the time curve of the first and of the second time period;

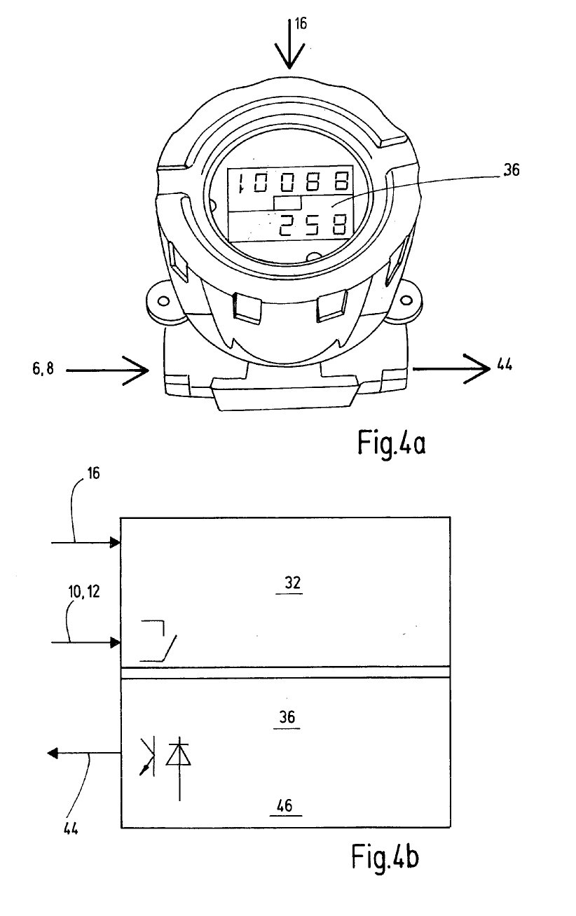

FIG. 4a shows a practical embodiment of the apparatus according to the invention including a display device, and

FIG. 4b shows a depiction of the interfaces of the apparatus according to the invention.

The left portion of FIG. 1 shows an arrangement known from the prior art, in which a spatially remotely situated electrical consumer 2′, here designed as a relay coil 2′ of a motor relay, is connectable to a control voltage source 4′ via the control lines 6′ and 8′. For this purpose, the known solution includes a mechanical pressure switch 30′, which establishes the connection of the consumer 2′ to the control voltage source 4′ at its control outputs 10′, 12′, as a function of the state variable of a fluid, specifically, in particular, as a function of the pressure of the fluid.

Such an arrangement is used, for example, to automatically close the mechanical pressure switch 30′ when the system pressure drops, so as not to put an electric pump (not depicted) into operation and so as to raise the system pressure to the desired value. It is routinely the case that the control lines 6′, 8′ bridge a long distance and at least sections of the control lines 6′, 8′ are often situated in explosive areas.

The right portion of FIG. 1 depicts the solution according to the invention, in which a measurement transducer 14 acted upon by a state variable 16 converts the detected value of the state variable into an electrical signal 18, which is evaluated by an evaluation unit 32 in the electronics device 20 of the apparatus. The control device 34 will then perform a control of the apparatus as a function of the evaluation. If the evaluation reveals that the detected value of the state variable 16 of the fluid exceeds or falls below a selectable threshold value, and the consumer 2 is to be connected to the control voltage source 4, the connection of the remote consumer 2 to the control voltage source 4 is established via the controllable electronic switching device 26 at least over a first pre-definable time period 22 (see FIG. 3). The power supply device 28 is fed from the voltage of the control voltage source 4 present at the control output 10, 12 of the apparatus via the control lines 6, 8, at least over a further, second time period 24 (see FIG. 3), which falls outside the first time period 22, thus, i.e., at times during which the electronic switching device 26 establishes no connection of the consumer 2 to the control voltage source 4. To control the electronic switching device 26, said device includes a control input 38, which is a gate of a triac 26 in the exemplary embodiment depicted, and via which the control device 34 is able to switch the triac 26 so that the latter establishes a connection between the control outputs 10 and 12 (triac-conductive) or establishes no connection (triac non-conductive).

According to the depiction in FIG. 2, the display device 36 and the evaluation device 32 are supplied from the power supply device 28 via a first isolation transformer for galvanic isolation. Similarly, the electronic switching device 26 (triac) is controlled at its control input 38 via a second isolation transformer 42, via which a galvanic isolation from the control device 34 is implemented. As an alternative to the galvanic isolation via the second isolation transformer 42, an optocoupler may also be provided for this purpose which achieves the isolation.

The second time period 24, in which the voltage of the control voltage source 4 feeds the power supply device 28, requires approximately 40°, for example, with respect to a half oscillation extending over an angle of 180° of the control voltage source 4 designed as an AC voltage source. The electronic switching device thus designed is then transferred to its conductive state upon ignition of the triac 26. In this case, in order not to have to accept any losses in the power supply tolerance for supplying the remotely situated electrical consumer 2, it is provided that, given a sufficient number of periods or half-periods, the triac 26 with ignites a suitable phase angle. As a result, the action of the switching device 26 virtually corresponds to that of an ideal contact and in this way, the safe energization of a load relay, controlled by the remotely situated electrical consumer 2 in the form of a relay coil, may be guaranteed.

In any case, the duration of the second time period 24 selected must be long enough so that the electronic device 20 of the apparatus is sufficiently supplied during periodic recurrence.

To obtain the required voltages and/or currents for supplying the apparatus, the power supply device 28 includes, in particular, electronic converters, for example, so-called flyback converters, which are available as largely integrated circuits. Such converters are noted for their particularly high efficiency in converting energy and possess a high flexibility with respect to the choice of electrical input variables and output variables.

Since the remotely situated electrical consumer 2 in the exemplary embodiment depicted is a coil 2 of a relay, in particular, of a load relay, thus a predominantly inductive load, the phase of the current lags behind that of the voltage by up to 90°. A triac voltage monitoring provided in the control device 34 recognizes the voltage increase at the triac corresponding to a current value of approximately zero through the triac and controls a re-triggering of the triac. Since the triac is switched on and off in each case with a current of approximately zero, a low EMV interference level in particular, is also achieved as a result, which is extremely advantageous compared to a mechanical switch.

FIG. 3 schematically shows the first time period 22 as a function of the time t, during which the electronic switching device 26 is set in its conductive state, and the time period 24, during which the electronic switching device 26 is set in its non-conductive state. The electronic switching device 26 implemented in the form of triac 26 ignites during the transition from the second time period 24 to the first time period 22. The durations of the first time period 22 and of the second time period 24 depicted in FIG. 3 are to be understood as merely exemplary for explaining the functional principle of the invention, in particular, the duration of the second time period 24, adapted to the operating conditions of the apparatus according to the invention, may, for example, be below 90°, for example, approximately 40°. It should also be noted that in FIG. 3, serving merely to explain in principle the function of the device, and [sic] an influence of inductive load, in particular, if a relay coil is connected via a triac 26, is not taken into consideration.

A sinusoidal curve 48 corresponding to the voltage of the control voltage source is depicted by dashed lines in FIG. 3. During the recurring first time period 22, the remotely situated consumer 2 is supplied with a voltage, which corresponds to the extended sections 50 of the sinusoidal curve depicted. In the interest of optimally minimal heat build-up and/or of minimal energy consumption, the control device 34 of the apparatus will specify the duration of the first time period 22 short enough that a sufficient, so-called holding current is able to flow through the consumer to achieve a desired function.

FIGS. 4a and 4b depict a practical embodiment of the apparatus according to the invention—once in a physical form and once as a circuit diagram, wherein FIG. 4b again depicts the interfaces of the apparatus accessible from the outside. An input device 46, in particular, in the form of switches and/or push buttons is used to set the at least one threshold value and/or to parameterize the apparatus. A feedback output 44 is also depicted in FIG. 4b, as well as a light-emitting diode designed as part of the display device 36, which visually reproduces the state of the electronic switching device. The feedback output 44 may, in particular, also be galvanically implemented and, thus, as an insulated switch output of the apparatus. The galvanic isolation in this case may, for example, may be formed by an optocoupler, so that an independent signal for reporting the activity and/or the switching state of the switching device 26 may be provided via the feedback output 44 and may be fed, for example, to a higher level control. The LCD display of the display device 36 depicted in FIG. 4a may be designed to rotate, so that a flexible adaptation of the arrangement for simplified reading of the display device 36 may be implemented, independently of the installation of the remainder of the apparatus housing.

1. An apparatus for controlling the electrical connection of an electrical consumer (2), which is situated remotely from the apparatus, to a control voltage source (4) associated with said electrical consumer, wherein the control is performed by means of two control lines (6, 8), which bridge the spatial distance between the apparatus and the consumer along with the control voltage source, and which are connected to a control output (10, 12) of the device, wherein the device includes a transducer (14), which detects the value of a state variable (16) of a fluid, and wherein the connection is controlled as a function of the respectively detected value of the state variable (16) exceeding and/or falling below a selectable threshold value, characterized in that the transducer is formed by a measurement transducer (14), which converts the value of the respectively detected state variable (16) into an electrical signal (18), in that the apparatus has an electronics device (20) for evaluating said electrical signal (18) and for controlling the connection as a function of the evaluation, in that the connection is made by means of a controllable electronic switching device (26), which is connected to the control output (10, 12) of the apparatus, at least over a first pre-definable time period (22), and in that the power supply device (28) of the apparatus, as a function of the switching state of the electronic switching device, is fed from the voltage of the control voltage source (4) present at the control output (10, 12) of the apparatus via the control lines (6, 8), at least over a further, second time period (24) which falls outside the first time period.

2. The apparatus according to claim 1, characterized in that the electronic switching device (26) of the apparatus includes two switch outputs, each of which is connected to one of the control outputs (10, 12), and a control input (38), and that each one of the switch outputs is connected to one control line (6, 8) each at the ends of the control lines (6, 8) on the side of the apparatus.

3. The apparatus according to claim 3, characterized in that the switching device (26) includes a conductive or a non-conductive state between the two switch outputs as a function of a control signal present at the control input (38).

4. The apparatus according to claim 1, characterized in that, on the one hand, the control of the switching device (26) shifts the switching device (26) into the conductive state during the first time period (22) and there is a connection and, on the other hand, said switching device being set to the non-conductive state during the second time period (24), the voltage present at the switch outputs originating from the control voltage source (4) feeds the power supply device (28) of the apparatus.

5. The apparatus according to claim 1, characterized in that the control voltage source (4) is an AC voltage source, and that the sum of the duration of the first, pre-definable time period (22) and the second time period (24) equals the duration of one or multiple half-oscillations of the AC voltage source.

6. The apparatus according to claim 5, characterized in that the electronic switching device (26) is controlled in synchrony with the control voltage source (4) as part of a phase angle control of the apparatus.

7. The apparatus according to claim 6, characterized in that the phase angle control controls the first time period (22) in such a way that during periodic recurrence of this time period (22), the average current intensity flowing through the consumer (2) as so-called holding current intensity is just sufficient enough to maintain a function of the consumer (2), for example, the closed state of a relay contact, if the consumer (2) is formed by the relay coil of a relay.

8. The apparatus according to claim 6, characterized in that the phase angle control controls the first time period (22) in such a way that during periodic recurrence of this time period (22), the average current intensity flowing through the consumer (2) as so-called holding current intensity is not sufficient enough to maintain a function of the consumer (2), for example, the closed state of a relay contact, if the consumer (2) is formed by the relay coil of a relay, and that the second time period (24) lasts at least long enough that sufficient energy for supplying the apparatus is fed to the power supply device (28) during periodic recurrence of this time period (24).

9. The apparatus according to claim 6, characterized in that the phase angle control connects the electronic switching device (26) preferably during zero crossings of the voltage of the control voltage source (4), or during zero crossings of the current through the remotely situated consumer (2).

10. The apparatus according to claim 1, characterized in that the electronic switching device (26) is formed by at least a triac, a thyristor, bipolar transistors, an IGBT, a field effect transistor or at least one semiconductor relay or at least partially from a combination of the aforementioned components.

11. The apparatus according to claim 1, characterized in that the power supply device (28) provides an insulated supply voltage for at least a part of the apparatus via a first transformer (40).

12. The apparatus according to claim 1, characterized in that the apparatus includes a feedback output (44) for the switching state of the electronic switching device (26).

13. The apparatus according to claim 1, characterized in that the state variables of the fluid are formed by the pressure of the fluid.

14. The apparatus according to claim 1, characterized in that additional measurement transducers detect, in addition or alternatively to the pressure of the fluid, additional state variables, such as flow velocity, viscosity, degree of contamination or temperature of the fluid, and are considered in the evaluation for controlling the electronic switching device (26).

15. The apparatus according to claim 1, characterized in that the electronics device (20) includes at least one display device (36) for displaying the state variable (16) and/or the state of the electronic switching device (26), as well as an input device (46), which is used, in particular, in the form of switches and/or push buttons to set the at least one threshold value and/or to parameterize the device via a menu control.

16. The apparatus according to claim 1, characterized in that the apparatus includes a housing of the type, such that the apparatus in the form of a retrofit unit may replace a normal, conventional mechanical switch, which includes a mechanical transducer for a state variable (16) of the fluid and no power supply.
